(19) United States
(12) Patent Application Publication
(10) Pub. No.: US 2008/0105266 A1
(43) Pub. Date: May 8, 2008

(54) Therapeutic Massage Ramp

(76) Inventor: Marc Davis, Granada Hills, CA (US)

Correspondence Address: KEN DALLARA, LAW OFFICE OF KEN DALLARA, 2259 WARD AVE, SUITE 100, SIMI VALLEY, CA, 93065, US

(21) Appl. No.: 11/557,966

(22) Filed: Nov. 8, 2006

(51) Int. Cl. A61G 15/00

(52) U.S. Cl. 128/845

(57) ABSTRACT

In accordance with the specifications, drawings and claims of this application, applicant presents a easily portable device that permits the user to be in a relaxed, reduced stress pronated sitting position whereby the user may be subjected to massage. This device can be quickly setup and is adjustable to include a head rest, which is situated to perfect alignment of the head with the spine of the user, reducing stress and promoting proper posture. The user is free to watch television, sporting events or concerts being able to promote better posture and spinal alignment, preventing damaging stresses upon the skeletal and nervous systems. This device only supports the center or spinal region of the back, whereby the shoulders and arms are not impinged upon by being held in the same planar surface as the spine. One's spine, scapula and shoulder joints are not in the same plane or surface and should not be forced into planar alignment. This device provides support to the cervical and upper thoracic area. Due to it's design features in relation to the lack a close fitting support around the guteal region, there is a prevention of sacral pressure sores about the sacrum region and constriction of the sciatic nerve. The orthopedically designed device promotes proper attitude of the spine creating less tension on the components of the spine. The device is portable, light-weight and compact enough so as to enable the user to travel with the device or place under one's bed. This anatomically designed device is to promote postural stabilization where torso inclination is preferred, where stresses and tensions are decreased due to the increase of circulation as blood flow is not restricted to the absence of forced flexion upon the muscles of the upper back.

### FIELD OF INVENTION

There is a need to have a proper symbiotic mutually beneficial relationship between ones skull, cervical, thoracic, and spinural regions of the body while one is in a sitting position so as to reduce stresses and tensions. Potentially damaging forced flexion can permanently misalign ones skeletal system along with decreasing circulation in the torso.

The field of application for this invention is where one needs to seat or recline to relax or to receive a massage therapy. One needs to properly incline one's back along a surface that supports their back in such a manner as to preclude the build up of stresses and complications involved in sitting while one's back is supported in a unitary fashion without regard for the complexities and varying topography of one's back. This invention is also used in the field of massage therapy where a therapist is now able to properly access one's back and shoulders in a natural position not flat upon a bulky massage table.

### SUMMARY OF PRIOR ART

The prior art is replete with inventions disclosing the current state of the art in devices that aid in the promotion of massage or those that medically derive a benefit to the user.

Basic massage tables can be either permanent or transportable but generally have common basic design features. Permanent tables differs only from the transportable style as they are more rigidly built and can include other elements. U.S. Pat. No. 5,088,475 to Steffensmeier issued on Feb. 18, 1992 and U.S. Pat. No. 6,190,338 to Arndt issued on Feb. 20, 2001, both disclose a table whereby heat and or massage is supplied by rollers focusing on the spine region of the user who is presented in the supinated position. These tables are not designed for the user to be in the pronated position and do conform to the contours of the body. Transportable tables are flat tables, sometimes with individually adjustable head rests, as described in U.S. Pat. No. 4,943,041 to Romein issued on Jul. 24, 1990, some with detachable face rests, as described in U.S. Pat. No. 4,333,638 to Gillotti issued on Jun. 8, 1982 and some without any form of separate head rests, as in U.S. Pat. No. 5,606,755 to Romein issued on Mar. 4, 1997, U.S. Pat. No. 6,918,144 to Friedman issued on Jul. 19, 2005, and U.S. Pat. No. 6,000,345 to Gilloti issued on Dec. 14, 1999. The basic premise of the table is that the user is placed in a pronated position where the massage therapist is able to massage those parts of the body presented to them. The major issue presented by the prior art include the inability of these portable tables to contour to the body while in the prone position. The front of one's body is not flat as the table, and especially females. U.S. Pat. No. 6,934,988 to Wetzler et al, issued on Aug. 30, 2005 addresses this issue of the female anatomy. Unfortunately, the rest of the table is flat whereby the shoulders and hips are subjected to unnatural stresses due to the application of the body weight forcing the front of the body to conform to a flat table. Friedman introduces heat to the table but does not discloses any head support nor adaptability to female users.

Portable tables can even present themselves in terms of using a secondary object, such as a bed to act in concert with the table to provide support. U.S. Pat. No. 6,408,465 to Fleming issued on Jun. 25, 2002, discloses a one legged padded board supported by a bed thereby limiting the use to those uses near a bed and does not produce a relaxed body as the table does not contour to the pronated or supinated body. Other bed supported devices are head or face rests adjusted to the user as they are lying on the bed. U.S. Pat. No. 6,151,734 to Lawrie issued on Nov. 28, 2000 and U.S. Pat. No. 6,148,460 to Fried et al issued on Nov. 21, 2000 disclose similar devices whereby one inserts a platform between the mattress and the boxspring and the other end of the platform is used to support one's face while laying in the pronated position. The bed does allow for the contours of the body and presents a more relaxed stress free body for the massage. The need for the use of a bed limits the transportability of the device.

Some tables are not tables at all, designed ergonomically about the human body to present one's body to the massage therapist in the most stress free of states. U.S. Pat. No. 5,642,542 details a device which is smaller in stature than a table and allows the user to be a more stress free position, along with accommodating users who are female or present issues prevent them from laying in a pronated position.

Massage stools, such as described by U.S. Pat. No. 5,401,078 to Riach issued on Mar. 28, 1995 and U.S. Pat. No. 5,971,485 to Clark issued on Oct. 26, 1999, are ergonomically designed to place the user in a supine position where the body is naturally relaxed due to the position of the legs, shoulders and back. These stools are made for clients who are not able to be presented on a massage table and by design hold the user in proper stress-free body alignment. The problems associated with these chairs, is that even though the user is completely relaxed and whose body is held in proper alignment, the user is unable to perform any other tasks and due to the bulkiness of the device, it is not suitable for quick assembly and transportability by the user.

While the user is being massaged or whose body is being held in a proper alignment, the user should be able to perform other tasks, like watching television or sporting events. The user should be able to move this device with minimal effort to varying locations, such as in the bed or on the beach. Bed bound sitting devices, such as disclosed in U.S. Pat. No. 5,765,244 to Heidler issued on Jun. 16, 1998 attaches to the bed by being held by the mattress and is capable of varying angles of inclination for the pronated user. This device does not separately hold the users head, thus the shoulders and the head are held in the same linear plane which is not natural, and the device is only usable when one is in bed. The fact that the shoulders, scapula and head are all on the same plane does not allow for a stress free natural alignment of the upper body.

In relation with portable chairs, used at the beach or otherwise basic designs incorporate the entire scauplar region extending downwardly toward the gluteal region. U.S. Pat. No. 4,470,630 to Shields issued on Spetember 11, 1984, U.S. Pat. No. 4,908,891 to Blagg issued on Mar. 20, 1990, U.S. Pat. No. 4,502,728 to Sheldon et al issued Mar. 5, 1985 and U.S. Pat. No. 4,079,993 to Pierce issued on Mar. 21, 1978 disclose varying styles of portable chairs used for viewing sporting events or used at the beach. All incorporate all encompassing surround designs providing an even plane for the spine and scapula without any support of the thoracic or cervical regions. These devices are not inclined thus the weight of the upper torso is being supported unnaturally by the lumbar region of the spine promoting an unnatural flexion of the region.

What is needed is a portable device, which is affordable and transportable by a single person to a variety of locations, which can hold the upper body in proper alignment while allowing the user to participate in other activities including being subjected to a massage. The body should be in the pronated position to accommodate those who are unable to lay supinated and should accommodate those bodily features of males and females that protrude outwardly away from the anterior of one's body. The head of the user should also be held in the proper alignment and the head rest should be adaptable to a variety of positions to accommodate users of different heights and requirements. This postural stablizing effect will increase circulation and will prevent the microtrauma associated with poor posture when sitting without proper alignment between the cervical region and the rest of the spine. This effect will also relax the lumbar region of the spine holding it in proper alignment without the added stresses of the weight of torso being unnaturally pressed up it.

It is an object of this invention to facilitate the proper location of the head in alignment with the spine for optimal relaxation of the muscles in the upper shoulder and neck regions. The position of the head is supported in a variety of position accommodating users of varying dimensions.

It is an object of this invention to facilitate access to the upper shoulder and back regions for the purpose of massaging those areas while the object of the massage is situated in a inclined sitting position benefiting from the construction of the invention.

It is an object of this invention to be portable whereby the user can transport this device and is capable of quick assembly procedures.

It is an object of this invention provide proper support and angle of incline that creates a position for the body to watch television or sporting events, in the house, or at the field, whereby the body is held in the correct position promoting better posture.

It is an object of this invention to create a situation where people who are unable to be in a pronated position due to pregnancy or surgery to receive the health benefits of massage.

It is an object of this invention to enable a massage therapist to perform therapy to bed ridden patients with only minimally invasive maneuvers to situate the patient into a proper position.

It is an object of this invention to create a device whereby victims of cervical injuries, such as cervical acceleration/deceleration syndrome or other hyperextension/hyperflexion injury to the spine or neck regions, and those with cervical spine curvature disorders, can rest in a sitting position that does not exacerbate their condition and promotes healing by reducing stresses compounded upon by sitting without correct support and posture.

### DESCRIPTION OF THE DRAWINGS

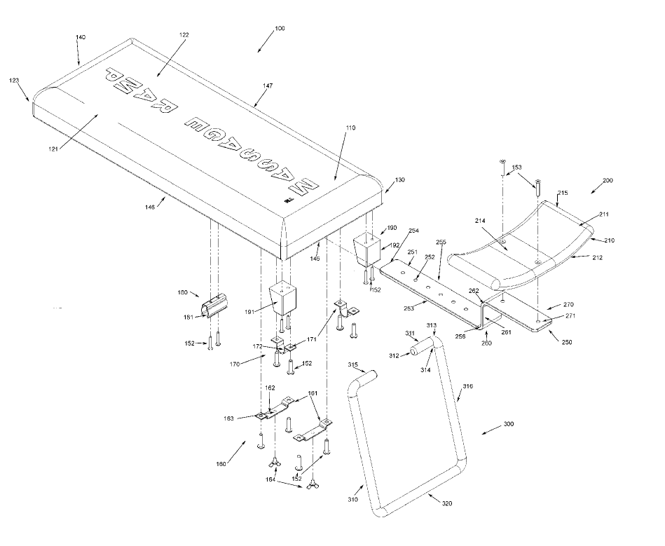

In FIG. 1, details an exploded view of the invention

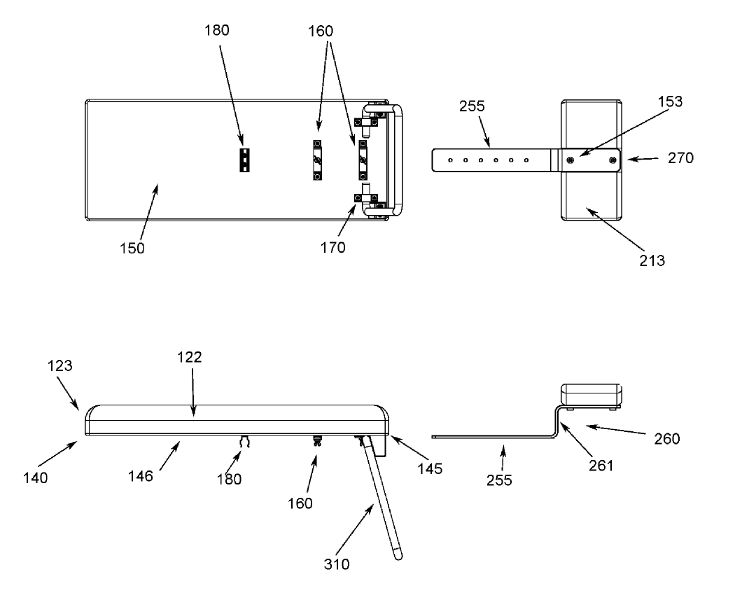

In FIG. 2, the rear portion of the board and head rest are shown and the inclination means is attached.

### DETAILED DESCRIPTION OF THE DRAWINGS

The best mode for practicing this invention will be herein described. Devices of similar materials and composition will be within the spirit of this invention. This invention combines two basic separate entities, each with it's own unique features along with an inclination means.

Massage Ramp 1 consists of three components; Body board 100, head rest 200 and variable inclination means 300. As seen in FIG. 1, Board 100 serves as the incorporating point of head rest 200 and inclination means 300. Board 100 has an anterior side 110 and a posterior side 150 is made of a sturdy material, capable of impact, elongation and torsional forces produced by the load of the body pressing against the anterior side 110, capable of receiving threaded inserts 151, and able to receive a comfort enhancement means 120 onto anterior side 110. In this invention, padded surface 120 is the comfort enhancement means comprising a close cell foam pad 121 encapsulated by a vinyl, or equivalent hypoallergenic, covering 122. Covering 122 can be made of any material that possesses the ability to withstand repeated compression, compatibility with various lotions, such as suntan lotions and oils, such as massage oils and essence, s and has sacrificial inhibitors that prevent degradation by UV radiation. Pad 121 is contoured as to fit board 100 and may contain beveled corners 123, enhancing appearance and reducing stresses on covering 122. The use of pad 121 as the comfort enhancement means does not preclude other such devices used to accomplish the means. Layers of clothes for those with allergies to vinyl or foam or a single layer of a substance solely used to protect the surface of board 100 would be included in the spirit of this invention. The object of providing the best surface for the application chosen by the user and or the therapist is accomplished by the comfort enhancement means.

In an embodiment, comfort enhancement means can be adapted to contain additional elements, such as pouches for heating or cooling elements, acupressure balls in alignment with pressure areas or other such therapeutic additives. In another embodiment, comfort enhancement means can be contoured to specifically target a particular area, such as the lumbar region to prevent lordosis or can be uniquely crafted to accommodate an individual spinal deformities, such as hyperkyphosis.

Board 100 has a head portion 130 and a butt end 140, but due to construction of board 100, there is symmetry about horizontal and vertical axes. Head Portion 130 is determined by choice. Board width 145 is critical to achieving the objectives of this invention. Board width 145 is the distance between board vertical laterals 146 and 147. Width 145 is such as to be placed comfortably along the spine of the user with the width 145 not exceeding the area between the scapular region of the user. Width 145 should not support the scapula of the user. It is critical for the user to have their scapula in a natural neutral position without being forced forward into the body by a flat surface that does not allow for natural posture. An object of this invention is satisfied as width 145 allows for massage therapist to access regions of the shoulders and neck which are not easily accessible when one is lying on their back due to the inability of the person to lay pronated. With the exposing of the shoulders and neck in this relaxed natural state, the massage therapist is able to complete their task from behind increasing the effectiveness of the therapy.

The variable inclination means used in this invention includes those devices which can adjust to and maintain an angle of inclination of the board between 0 and 90 degrees, in any multiple of degrees thereof, whether adjusted manually or through automated means. In the best mode for this invention, the variable inclination means is a rigid strut 310 but is not limited to this means of holding board 100 at a particular angle of inclination. Strut 310 in this invention consists of a hollow metallic bar stock that has been fashioned into a U shape. Strut 310 has a lower section 320 and upper section 315. Upper section 315 contains channel rotation segments 311 created by directing open end 312 inwardly toward the opposite side of the U shape of channel 310. Material used in the composition of strut 310 must be able to withstand the compression and hoop stresses caused by the forces of the weight of the user upon the board transmitted through to the supporting channel 130 and those stresses caused by the bending processes. In this invention, a single uniform stock was used, but other designs and materials can be used. Open end 312 is encapsulated to prevent contamination by either inclusion of a cap or sealed by other means. Care must be taken to not rupture inner crease 314 of corner 313. Crease 314 should contain a radius to prevent a build up of stresses which can lead to failure.

Posterior side 150 incorporates inserts 151 and mating inserts 152. Mating inserts 152 consists of a male threaded bolt that is a companion to insert 151. Associated lock washers and flange washers my be used to facilitate manufacturing and product use parameters. Along with head rest attachment 160, channel attachment 170, and channel capture 180, posterior side 150 contains setoff posts 190. Channel attachment 170 consists of two U shaped flanges 171 attached to posterior side 150 by mating inserts 152, situated so that a substantial portion of channel rotational points 311 are encased by cover 172 but are not rotational restricted. Channel attachment 170 is located at the head portion 130 of board 100.

Head rest attachment 160 consists of a set of rectangular bar flanges 161 containing rectangular passageway 162 allows for the interface adjustment section 251 of head rest bar 250 therethrough. Head rest attachment 160 is located at the head portion 130 of board 100. Passageway 162 has passageway hole 163 centered through which adjustment wingnut 164 is inserted therethough into threaded adjustment hole 252 on adjustment section 251. In this invention, wingnuts are used for convenience, but any other means to attach head rest 200 to board 100 would be suitable. It is also possible to have slots through which wingnut 164 is placed therethrough rather than a simple hole to increase the adjustability range of head rest 200. This invention contains 2 rectangular bar flanges 161, but should this number can be increased or decreased depending on the weight of head rest 200 and the weight upon said head rest supplied by the user. The distance between the rectangular bar flanges will coincide with a multiple of the distance between the adjustment holes 252 on adjustment section 251. Flanges 161 are attached to posterior portion of board 150 by mating inserts 152 into insert 151 pre-positioned onto anterior portion 150 of board 100.

Channel capture 180 consists of capture grip 181 and mating inserts 152 and associated inserts 151 located on anterior portion 150. Grip 181 is designed to accept lower section 320 in such a manner as to prevent it's dislodgement except when the user applies a small amount force. Shape and character of grip 181 is not critical to the functioning of this invention and many apparatus are available to perform this function. In this invention, grip 181 is similar to pipe conduit hangers used to attach piping to vertical or horizontal structures. Grip 181 is attached to attached to posterior portion of board 150 by mating inserts 152 into insert 151 pre-positioned onto anterior portion 150 of board 100. Location of channel capture 180 is dictated by the length the vertical member 316 of strut 310 at a distance away from head portion 130 of board 100.

Offset posts 190 consists of at least one supporting buttress 191, preferably two buttresses are used attached to the anterior portion of board 150 by mating inserts 152 into insert 151 pre-positioned onto posterior portion 150 of board 100. Buttress 191 is located at the head portion 130 of board 100. Height component 192 of buttress 191 is at least the horizontal component of strut 310 and can be increased by discretion of the user.

Head rest 200 consists of interface adjustment section 251, containing multiple threaded adjustment holes 252, both located upon lower horizontal tang 255 of head rest bar 250, vertical offset 260 which separates lower tang 255 from upper horizontal tang 270 and cradle 210. In this invention, vertical offset is a fixed distance calculated to bring the users head in line with the lower skeletal structure and thoracic region, but an adjustable offset can be used. Other degrees of mechanical freedom including rotational and other translations are available Lower tang 255 has distal end 254 and proximal end 256 along vertical length 253, interspersed therebetween are multiple occurrences of threaded adjustment hole 252, equally spaced and centered horizontally. Vertical offset 260 has offset height component 261, which is located upon proximal end 256 of bar 250, is critical to the positioning of the head in relation to the spine of the user. Height component 261 is of such length as to promote skeletal alignment between the thoracic and cervical regions of the spine thereby minimizing forced torso flexion terminating at maximum height element 262. It is an object of this invention to prevent microtrauma associated with improper posture when one is watching television, sporting events or reading. When one's neck is inclined rather than the torso being inclined or when the head is unsupported, the user can experience hyperkyphosis or lordosis. This invention has accomplished this objective by the use of the vertical offset 260 and board width 145. Upper tang 270 is perpendicular to height component 261 emanating from height element 262. Upper tang 270 creates support area for cradle 210 and contains multiple connection points 271 whereby cradle 210 is attached to upper tang 270 using connectors 153. Cradle 210 is has an upper pad 211 and a lower stiffener 213. External ends 215 of stiffener 213 is shaped in an arc of curvature 212, where spine flat 214 is centrally located along the horizontal axis of stiffener 213. Curvature 212 serves to center the users head, neck and spine and prevents misalignment. Spine flat 214, throughwhich connectors 153 are inserted, is the central attachment point of head rest 200 to upper tang 270.

This detailed description discloses the best mode of practicing this invention but does not limit the scope of this invention to only materials and compositions notated herein. It is obvious that one skilled in the art can develop alternative methods to accomplished the objects of this invention, but this disclosure and subsequent claims develop the scope of this invention.

What is claimed is:

1. A therapeutic inclined massage ramp uniquely crafted to minimize upper thoracic stresses by providing proper support to the thoracic, scapular and spinular regions and creating a platform providing necessary access to neck and shoulder regions while receiving massage therapy in the pronoated position consisting;
a back supporting member comprising of an head and a butt region, a front and a rear surface, a vertical component aligned along said head and said butt regions, and a horizontal component perpendicular to said vertical component parallel with said front and said back surfaces;
a variable position head rest with at least 2 degrees of mechanical freedom attached to said rear surface of said back support;
a variable inclination means comprising a securement means and an attachment means connecting said rear surface of said back supporting member to said inclination means; and
a comfort enhancement means encasing said front surface of said back supporting surface.

2. A therapeutic inclined massage ramp as in claim 1 where said comfort enhancement means comprises a section of light porous semirigid material used for shock absorption encased on at least all exposed surfaces with a covering.

3. A therapeutic inclined massage ramp as in claim 1 where said horizontal component of said back supporting member is adapted not to exceed the span of the scapular region.

4. A therapeutic inclined massage ramp as in claim 1 where said a variable position head rest two degrees of freedom are along said vertical axis of said back supporting member.

5. A therapeutic inclined massage ramp as in claim 1 where said a variable position head rest holds the upper and lower thoracic regions and cervical region in proper alignment.

6. A therapeutic inclined massage ramp as in claim 1 where said a variable inclination means adapts said massage ramp from being parallel to being perpendicular to a surface said ramp is positioned thereon pivoting upon said butt end of said back supporting member.

7. A therapeutic inclined massage ramp uniquely crafted to minimize upper thoracic stresses by providing proper support to the thoracic, scapular and spinular regions and creating a platform providing necessary access to neck and shoulder regions while receiving massage therapy in the pronoated position consisting;
a back supporting member comprising of an head and a butt region, a front and a rear surface, a vertical component aligned along said head and said butt regions, and a horizontal component perpendicular to said vertical component parallel with said front and said back surfaces;
a variable position head rest with at least 2 degrees of mechanical freedom attached to said rear surface of said back support;
a variable inclination means comprising a securement means and an attachment means connecting said rear surface of said back supporting member to said inclination means; and
a comfort enhancement means encasing said front surface of said back supporting surface, said comfort enhancement means having a hypoallergenic covering.

8. A therapeutic inclined massage ramp as in claim 7 where said comfort enhancement means comprises a section of light porous semirigid material into which devices have been placed encapsulated by said material.

9. A therapeutic inclined massage ramp as in claim 7 where said comfort enhancement means comprises a section of light porous semirigid material in which contains saclike structures for purposes of insertion of therapeutic or temperature regulation devices.

10. A therapeutic inclined massage ramp as in claim 7 where said comfort enhancement means comprises a section of light porous semirigid material which is contoured to provide support to various skeletal regions.
